(19) United States
(12) Patent Application Publication
(10) Pub. No.: US 2010/0027265 A1
(43) Pub. Date: Feb. 4, 2010

(54) LAMP ARRANGEMENT WITH A COOLING DEVICE

(75) Inventors: Andre Nauen, Jiangsu (CN); Simon Lankes, Falkensee (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/532,152

(22) PCT Filed: Apr. 3, 2007
(86) PCT No.: PCT/EP07/53238

§ 371 Date: Sep. 20, 2009

(51) Int. Cl. F21V 29/00

(52) U.S. Cl. 362/264

(57) ABSTRACT

A lamp arrangement is provided. The lamp arrangement may include a cooling device, which has a reflector housing and a lamp vessel of a lamp, which lamp vessel passes through a cutout in the reflector housing and is cooled by means of the cooling device, wherein the cooling device has a cooling fluid inlet cutout and a cooling fluid outlet cutout, which are provided on the opposite end sections of the lamp vessel within or adjacent to the cutout in the reflector housing.

### TECHNICAL FIELD

The invention is based on a lamp arrangement with a cooling device which can be used in particular for high-pressure discharge lamps, more preferably for projector lamps.

### PRIOR ART

Ultra-high-pressure gas discharge lamps, as are used in video projection, for example, require precise cooling in order to ensure the specified life. In particular, it has been shown that the temperatures on the outside of the burner vessel need to be within a lamp-specific temperature range, i.e. it is absolutely necessary for both excessively high and excessively low temperatures to be avoided. Owing to the convection of the fill gases in the discharge vessel, in this case an increased cooling requirement on the upper side of the discharge vessel and a much lower cooling requirement on the lower side thereof result.

In general, video projectors are operated in two installed positions, which are offset with respect to one another through 180°. The choice of installed position is dependent on whether the video projector is standing on a flat surface or is mounted in suspended fashion. In this case, the lamps are also rotated correspondingly. In both installed positions, the predetermined temperatures on the outside of the discharge vessel need to be maintained.

The laid-open specification DE 101 00 724 A1 describes cooling by means of a nozzle arranged in the lamp reflector. This allows for precise cooling of the upper side of the discharge vessel, which side is subject to the greatest thermal loading. At the same time, the cooling effect on the lower side which is subjected to little thermal loading is markedly reduced, with the result that the minimum temperatures required for reliable operation can be maintained. Owing to the fact that the cooling device is arranged in a manner which is asymmetrical in the event of a rotation through 1800, a corresponding change in the installed position cannot be realized, however.

One solution, as disclosed in the patent US 2006/0226752 A1, does realize cooling which is designed to be rotationally symmetrical. However, it is not possible for the cooling to be matched to the natural temperature distribution of the ultra-high-pressure discharge light source. For example, setting the cooling air flow in such a way that a temperature which is favorable as regards the tendency for devitrification results on the upper side of the discharge bulb would bring about a temperature on the lower side which is unfavorable for the operation of the critical cyclic process.

During operation of an ultra-high-pressure gas discharge lamp, there is always a certain degree of probability of explosion. For example, the document JP 2001-307535A describes the embodiment of a reflector ultra-high-pressure gas discharge lamp which prevents the occurrence of fragments in the event of the explosion of the discharge vessel. The lamp system is in this case not entirely closed, however, with the result that gaseous parts of the fill of the discharge lamp can emerge.

### DESCRIPTION OF THE INVENTION

The object of the present invention is to provide a lamp arrangement with a cooling device, in the case of which efficient cooling, in particular of high-pressure discharge lamps, is made possible, in particular when providing two installed positions which are offset through 1800.

This object is achieved by the subject matter of patent claim 1.

Particularly advantageous refinements are given in the dependent claims.

The invention discloses a lamp arrangement with a cooling device, which has a reflector housing and a lamp vessel of a lamp, which lamp vessel passes through a cutout in the reflector housing and is cooled by means of the cooling device. The cooling device has a cooling fluid inlet cutout and a cooling fluid outlet cutout, which are provided on the opposite end sections of the lamp vessel within or adjacent to the cutout in the reflector housing. Since, in this way, the cooling fluid can enter through the upper inlet at a high speed and can emerge directly adjacent to the lower outlet at high speed, a desired cooling process can be implemented with little complexity. In addition, this makes it possible for the lamp vessel to be arranged in such a way as to be offset through 180° with respect to the lamp axis. In the event of a change in position of the lamp arrangement in a projector, for example from an upright projector to a suspended projector, the role of the inflow and extraction openings can therefore be swapped over, with the result that the greater cooling effect is provided unchanged at the upper side of the lamp vessel which is subjected to a greater thermal load.

Corresponding to a development, the cross section of the cooling fluid inlet cutout and of the cooling fluid outlet cutout in each case has the shape of a ring section.

In a preferred embodiment, each ring section extends around the lamp vessel at an angle of approximately 180°. In this way, a uniform cooling effect can be implemented whilst maintaining the required temperatures at the lower side of the lamp vessel.

It is advantageous if the cooling fluid inlet cutout and the cooling fluid outlet cutout are connected to one another outside the reflector housing via a pump. This makes it possible to provide targeted cooling of the lamp vessel which is independent of position.

In one development, an opening, which is arranged at the opposite end section of the reflector housing with respect to the cutout in said reflector housing, is closed by a face plate. This provides a closed system with emission freedom, in particular as regards volatile constituents of the gas fill, in the event of an explosion. If any desired type of heat exchanger is added, the system is completely encapsulated, with the result that noise development is also reduced in addition to the prevention of gaseous and particulate emissions. In the case of a closed embodiment, an advantageous coolant flow via the front end of the lamp vessel and the power supply line situated there results.

In one alternative, the cooling fluid inlet cutout and the cooling fluid outlet cutout outside the reflector housing are each assigned a pump. In this case, the direction of rotation of the pump can be set corresponding to the installed position of the lamp vessel. By virtue of in each case one cold trap assigned to the respective pump, an emission of condensable constituents can largely be reduced in the event of a explosion.

In the installed position, the cooling fluid inlet cutout is preferably arranged above the lamp vessel and the cooling fluid outlet cutout is preferably arranged below the lamp vessel. As a result, a good cooling effect above the lamp vessel can be implemented whilst maintaining the cyclic process by preventing the minimum temperature from being undershot beneath the lamp vessel.

In a further variant, the cooling fluid inlet cutout and the cooling fluid outlet cutout each have a nozzle in order to enable accelerated delivery of the cooling fluid. The nozzles preferably have identical geometries, irrespective of the closed or open cooling cycle.

The lamp is preferably a high-pressure discharge lamp since, owing to the forced cooling in accordance with the present invention, devitrification and therefore a reduction in the life can be avoided.

### BRIEF DESCRIPTION OF THE DRAWINGS

The invention will be explained in more detail below with reference to two exemplary embodiments. In the figures:

FIG. 1 shows a basic illustration of a lamp arrangement with a cooling device corresponding to the first exemplary embodiment,

FIG. 2 shows a basic illustration of a lamp arrangement with a cooling device corresponding to the second exemplary embodiment of the invention, and

FIGS. 3A, 3B, 3C, 3D show a further lamp arrangement with a cooling device, in which the first and second exemplary embodiments can be used, in a side view, a view from the rear, a view at an angle from the rear and as an enlarged detail of the view at an angle from the rear.

### PREFERRED EMBODIMENT OF THE INVENTION

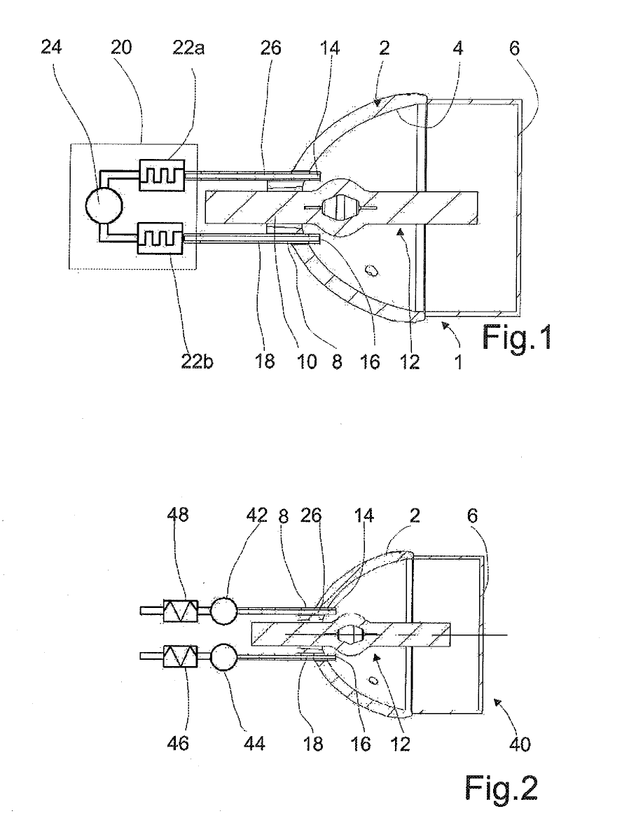

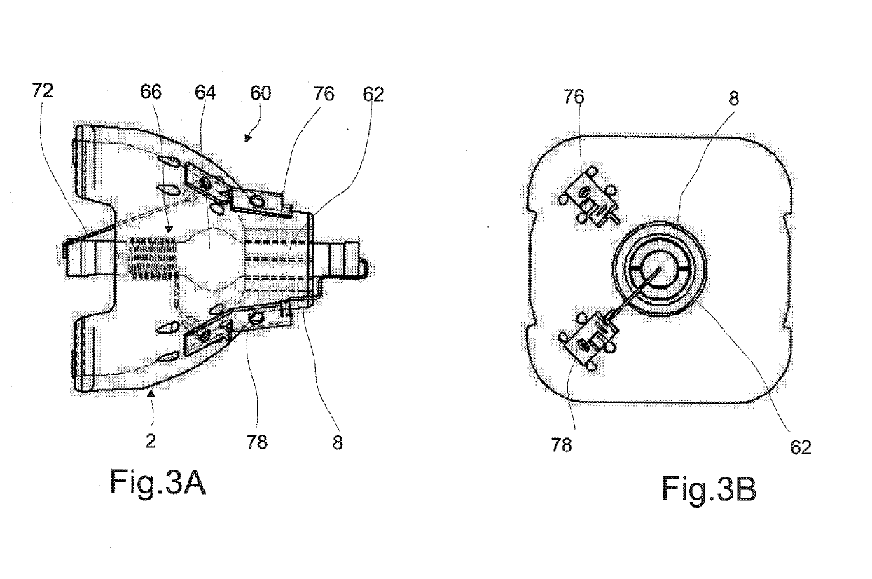

The inventors of the present invention have found in their investigations that it is advantageous for effective forced cooling for a specific ultra-high temperature to be present in the installed state of a lamp arrangement on the bulb outer side, but temperatures below a specific minimum temperature are undesirable on the lower side, since it is not ensured that the cyclic process is maintained at temperatures below this minimum temperature. In order to implement the mentioned temperature profile, the inventors have developed the first and second exemplary embodiments shown in FIGS. 1 and 2.

FIG. 1 shows a schematic illustration of the lamp arrangement 1 corresponding to the first exemplary embodiment. Said arrangement has a reflector housing 2, whose light-emitting opening 4 is closed by a face plate 6. The reflector neck 8, which is opposite the light-emitting opening 4, accommodates the tubular lamp vessel 10 of the high-pressure discharge lamp 12. The outer power supply lines are not shown in the basic illustration in FIG. 1. In the installed position above the tubular lamp vessel 10, a fluid outlet nozzle 14 is provided, while a fluid inlet nozzle 16 is arranged below the tubular lamp vessel 10 opposite the fluid outlet nozzle 14. The fluid inlet nozzle 16 is fluidically connected to a cooling cycle 20 via a fluid outlet cutout provided in the neck of the reflector housing 2. The fluid which is heated in the interior of the reflector housing 2 and emerges from the fluid outlet cutout 18 is received by the fluid inlet nozzle 16 and fed to a heat exchanger 22b via the fluid outlet cutout 18 and then fed to the fluid outlet nozzle 14 via a pump 24, which is connected downstream of the heat exchanger 22b, a further heat exchanger 22a and a fluid inlet cutout 26 in the reflector neck 8.

Thus, fresh cooling fluid is blown in onto the upper side of the high-pressure discharge lamp and extracted at the lower side of the high-pressure discharge lamp. If the lamp is rotated through 180° for operation, for example in the case of a change in the position of the projector from upright to suspended, the fluid inlet nozzle 14 and the fluid outlet nozzle 16 are reversed in terms of their respective function.

In investigations into the flow response of a lamp arrangement corresponding to the first exemplary embodiment, the inventors have established that the flow at the upper side of the high-pressure discharge lamp 12 is quick and directional, while high flow rates only occur on the lower side of the high-pressure discharge lamp directly adjacent to the fluid outlet nozzle 16. In this way, excessive cooling of the burner lower side can be avoided.

In the case of the lamp arrangement 1 corresponding the first exemplary embodiment, the power supply line, which extends from the tubular lamp vessel 10 in adjacent fashion towards the face plate 6, can be cooled during operation in order to prevent oxidation of the power supply line. The cooling effect can be increased by virtue of the effective surface of the power supply line being enlarged, for example via a platelet made from thermally conductive material, for example metal, being applied.

In addition, the flow response within the lamp arrangement 1 can be improved by a corresponding design of the reflector housing in the area adjacent to the face plate, which area is of only low optical relevance.

In the first exemplary embodiment, air or other suitable gases can be used, for example, as the fluid for the cooling. Since the fluid inlet nozzle 14 and the fluid outlet nozzle 16 are located in an area in which there is no or negligibly little incident light, the luminous efficiency is only reduced to a small degree by a cooling system corresponding to the present invention.

Since, in the event of a rotation of the lamp through 180°, the fluid inlet nozzle 14 and the fluid outlet nozzle 16 reverse their functions, it is necessary to change the delivery direction of the pump, with the result that the fluid flows into the reflector housing 2 always through the upper nozzle. For this purpose it is advantageous for a heat exchanger 22a, 22b to be provided both upstream of the pump, which changes the delivery direction in the event of such a change, and downstream of the pump, as is shown in FIG. 1.

Since the lamp arrangement corresponding to the first exemplary embodiment involves an encapsulated system, the emission of mercury in the case of the high-pressure discharge lamp exploding can be prevented even when mercury high-pressure discharge lamps are used. The mercury remains in the cooling cycle 20.

FIG. 2 shows a lamp arrangement 40 corresponding to the second exemplary embodiment. Elements and sections which correspond to those in the first exemplary embodiment have been provided with the same reference symbols.

A fluid inlet cutout 26 and a fluid outlet nozzle 14 and a fluid inlet nozzle 16 and a fluid outlet cutout 18 are likewise provided in the neck 8 of the reflector housing 2 of the lamp arrangement 40 of the second exemplary embodiment.

In contrast to the first exemplary embodiment, the cooling cycle of the lamp arrangement 40 of the second exemplary embodiment is open. For this purpose, a pump 42, 44 is assigned to each of the nozzles 14, 16, instead of the pump 24 of the first exemplary embodiment. The pump 42 assigned to the upper nozzle, the fluid outlet nozzle 14 in FIG. 2, pushes cool air into the reflector, while the pump 44 assigned to the lower nozzle, the fluid inlet nozzle 16 in FIG. 2, extracts the heated air. It is advantageous if the two pumps 42, 44 have the same delivery power.

If the lamp arrangement 40 is used in a position in which it is rotated through 180°, the delivery direction of the pumps 42 and 44 is reversed. In FIG. 2, in addition a cold trap 46 is arranged downstream of the pump 44 and a cold trap 48 is arranged upstream of the pump 42. Such cold traps can ensure that extensive condensation of the mercury takes place when using mercury high-pressure discharge lamps and the discharge vessel explodes. Thus, even in the case of an open cooling cycle of the lamp arrangement in the second exemplary embodiment, increased operational reliability is ensured in comparison with the prior art.

Instead of a face plate, a suitably optically transparent closure of the front reflector opening may be provided in the lamp arrangements of the first and second exemplary embodiments.

The above described lamp arrangement can advantageously be used in the case of high-pressure discharge lamps with holding ceramics. If the lamp vessel is cemented, a simpler and less expensive design can be achieved.

In the case of lamps without holding ceramics, the burner is introduced into the reflector neck and fixed by means of a heat-curing cement. In order not to reduce the mechanical stability of such a joint, it is not recommended to introduce the fluid outlet cutout and fluid inlet cutout for cooling the lamp vessel of the high-pressure discharge lamp in this cement. It is therefore possible to provide cutouts in the form of bores in the reflector housing. Such machining of the reflector housing is often cost-intensive, however, and results in losses in luminous flux.

As an alternative to fixing the lamp vessel in the reflector housing exclusively using cement, fixing by means of a sleeve 62 is performed in the case of the lamp arrangement 60 of the variant below for the first and second exemplary embodiments. The lamp vessel 64 of the high-pressure discharge lamp 66 is surrounded by the sleeve 62 and held in the reflector neck 8 of the reflector housing 2 by the outer circumference of the sleeve 62.

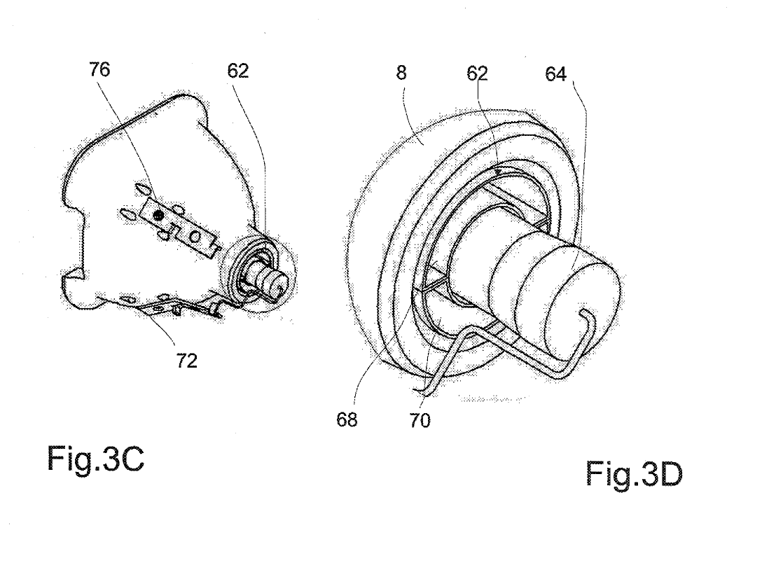

FIG. 3A shows a side view of the lamp arrangement 60, FIG. 3B shows a view from the rear of the lamp arrangement 60, FIG. 3C shows a perspective view from the rear of the lamp arrangement 60, and FIG. 3D shows an enlarged area adjacent to the reflector neck 8 in the lamp arrangement 60. It is apparent from FIGS. 3B and 3D that the sleeve 62 has a cylindrical inner cutout, and the interior which is delimited between the inner wall and the outer wall is formed in such a way that two ring sections are provided, which each cover substantially 180°. The upper ring section 68 is comparable in terms of function with the fluid outlet nozzle 14 in FIGS. 1 and 2, while the lower ring section 70 is comparable with the fluid inlet nozzle 16. The sleeve 62 is preferably metallic and can additionally be used as an antenna for starting the burner, by virtue of said burner being constructed in the reflector in oriented fashion with a so-called auxiliary starting bubble, as described in the document WO03/085695A1.

The sleeve 62 of the variant corresponding to FIGS. 3A to 3D has both a holding function in respect of the lamp vessel 64 and the function of the passage of the coolant or of the heated coolant for use with cooling cycles corresponding to the first and secondary embodiments, respectively. Even in the case of the variant corresponding to FIGS. 3A to 3D, a face plate for covering the reflector housing can be used.

FIG. 3A shows the power supply line 72 adjacent to the open end of the reflector housing 2. Said power supply line is cooled by the coolant, as has been described in relation to the first exemplary embodiment. The outer power supply line 72 is connected to a contact 76 provided on the reflector housing 2, while an inner power supply line 74, which is located on that part of the lamp vessel 64 which passes through the reflector neck 8, is electrically connected to a contact 78.

By virtue of the present invention, effective cooling of the lamp vessel of a high-pressure discharge lamp can be implemented, wherein it is possible to prevent the emergence of fragments or of fluids from the lamp vessel by virtue of the design of the cooling cycle for the case in which the lamp vessel explodes.

1. A lamp arrangement, comprising: a cooling device, which comprises reflector housing and a lamp vessel of a lamp, which lamp vessel passes through a cutout in the reflector housing and is cooled by means of the cooling device, wherein the cooling device has a cooling fluid inlet cutout and a cooling fluid outlet cutout, which are provided on the opposite end sections of the lamp vessel within or adjacent to the cutout in the reflector housing.

2. The lamp arrangement as claimed in claim 1, wherein the cross section of the cooling fluid inlet cutout and of the cooling fluid outlet cutout in each case has the shape of a ring section.

3. The lamp arrangement as claimed in claim 2, wherein each ring section extends around the lamp vessel at an angle of approximately 180°.

4. The lamp arrangement as claimed in claim 1, wherein the cooling fluid inlet cutout and the cooling fluid outlet cutout are connected to one another outside the reflector housing via a pump and at least one heat exchanger.

5. The lamp arrangement as claimed in claim 4, wherein an opening, which is arranged at the opposite end section of the reflector housing with respect to the cutout in said reflector housing, is closed by a face plate.

6. The lamp arrangement as claimed in claim 1, wherein the cooling fluid inlet cutout and the cooling fluid outlet cutout outside the reflector housing are each assigned a pump and a respective cold trap for the condensation of emerging constituents.

7. The lamp arrangement as claimed in claim 1, wherein, in the installed position, the cooling fluid inlet cutout is arranged above the lamp vessel and the cooling fluid outlet cutout is arranged below the lamp vessel.

8. The lamp arrangement as claimed in claim 1, wherein the cooling fluid inlet cutout and the cooling fluid outlet cutout each have a nozzle.

9. The lamp arrangement as claimed in claim 1, wherein the lamp is a high-pressure discharge lamp.
